(19) United States
(12) Patent Application Publication
(10) Pub. No.: US 2025/0117351 A1
(43) Pub. Date: Apr. 10, 2025

(54) SERVER SYSTEM, AND METHOD FOR IMPLEMENTING HOT- SWAPPING ON A SERVER

(71) Applicant: Shanghai Zhaoxin Semiconductor Co., Ltd., Shanghai (CN)

(72) Inventors: Qian ZHANG, Beijing (CN); Jintao WANG, Beijing (CN)

(21) Appl. No.: 18/414,794

(22) Filed: Jan. 17, 2024

(30) Foreign Application Priority Data
Oct. 8, 2023 (CN) 202311294195.0

(51) Int. Cl. G06F 13/40; G06F 13/24

(52) U.S. Cl. CPC G06F 13/4081; G06F 13/24

(57) ABSTRACT

A server with solid-state drive (SSD) hot-swapping capability is shown. The central processing unit (CPU) of the server has a system control interrupt (SCI) pin for receiving an SCI alert signal. The alert status of the SCI alert signal is changed in response to any hot-swapping event happening among a plurality of SSD ports on the backplane of the server. In response to the alert status of the SCI status signal, the CPU calls an SCI handler to deal with the hot-swapping event.

### CROSS REFERENCE TO RELATED APPLICATIONS

This application claims priority of China Patent Application No. 202311294195.0, filed on Oct. 8, 2023, the entirety of which is incorporated by reference herein.

### BACKGROUND OF THE DISCLOSURE

### Field of the Disclosure

The present disclosure relates to a server, and in particular to a server that supports hot swapping of solid-state drives (SSDs).

### Description of the Related Art

A server system may include multiple solid-state drives (SSDs) through a backplane. How to implement SSD hot swapping on a server is an important issue in this technical field.

### BRIEF SUMMARY OF THE DISCLOSURE

A server system in accordance with an exemplary embodiment of the disclosure has a central processing unit (CPU). The CPU has a system control interrupt (SCI) pin operative to receive an SCI alert signal, wherein the alert status of the SCI alert signal reflects a hot-swapping event occurred at a solid-state drive (SSD) port on the backplane. In response to the alert status of the SCI alert signal, the CPU calls an SCI handler to handle the hot-swapping event.

In another exemplary embodiment, a method for implementing SSD hot-swapping on a server is shown. The method includes receiving an SCI alert signal via an SCI pin of a CPU. The alert status from the SCI alert signal reflects a hot-swapping event at an SSD port of the backplane. In response to the alert status of the SCI alert signal, the method includes operating the CPU to call an SCI handler to handle the hot-swapping event.

Through the proposed server system and method, the CPU is notified of a hot-swapping event occurred at an SSD port through an SCI pin of the CPU. Hot-swapping of an SSD on the server is allowed.

A detailed description is given in the following embodiments with reference to the accompanying drawings.

### BRIEF DESCRIPTION OF THE DRAWINGS

The present disclosure can be more fully understood by reading the subsequent detailed description and examples with references made to the accompanying drawings, wherein:

FIG. 1 shows a server system 100 in accordance with an exemplary embodiment of the disclosure;

FIG. 2 illustrates a server system 200 in accordance with another exemplary embodiment of the disclosure (wherein the motherboard 202 provides a logic “AND” gate receiving interrupt alert signals from the different SSD ports);

FIG. 3 shows a waveform diagram illustrating how the SCI alert signal (or the interrupt alert signals Alert #) changes with the hot swapping events;

FIG. 4A shows a timing diagram 400 illustrating the interaction between the user, firmware (Basic Input Output System, abbreviated as BIOS), and operating system (OS) when a hot plugging-out event has occurred;

FIG. 4B shows a timing diagram 420 illustrating the interaction between the user, firmware (BIOS), and operating system (OS) when a hot plugging-in event has occurred;

FIG. 5A illustrates the server's processing flow about a hot plugging-out event;

FIG. 5B illustrates the server's processing flow about a hot plugging-in event; and

FIG. 6 is a flow chart illustrating the actions of the SCI handler executed by the firmware (BIOS).

### DETAILED DESCRIPTION OF THE DISCLOSURE

The following description is made for the purpose of illustrating the general principles of the disclosure and should not be taken in a limiting sense. The scope of the disclosure is best determined by reference to the appended claims.

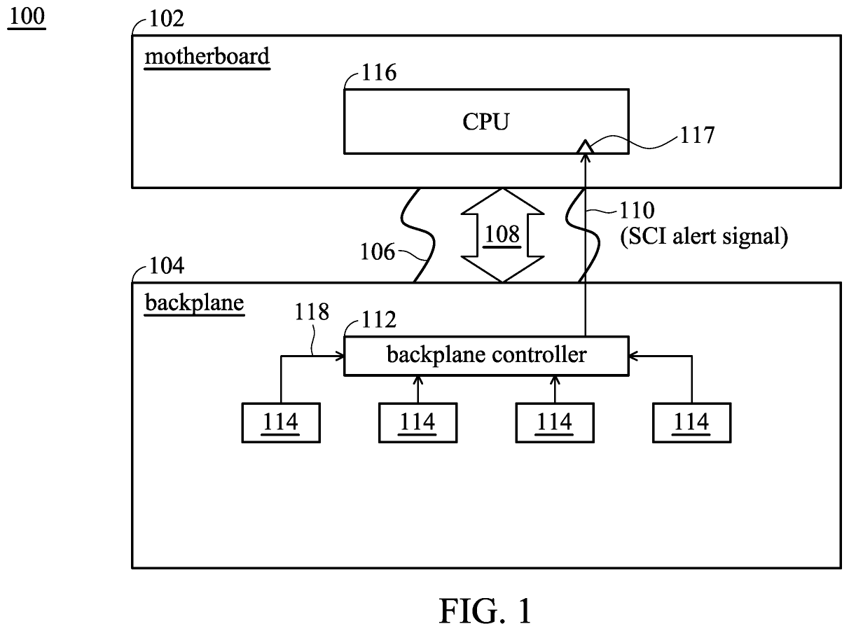

FIG. 1 shows a server system 100 in accordance with an exemplary embodiment of the disclosure, including a motherboard 102 and a backplane 104. The motherboard 102 and the backplane 104 are connected by a connection cable 106. In addition to a bus 108, the connection cable 106 also includes a transmission line 110 for transferring a system-control-interrupt (SCI) alert signal. The bus 108 can be any bus that supports a peripheral component interconnect express (PCIe) protocol, such as a SLIMLINE bus, a PCIe bus, and so on. In an exemplary embodiment, the bus 108 meets the PCIe 8GT rate. The backplane 104 includes a backplane controller 112 and provides a plurality of solid-state drive (SSD) ports 114 for plugging in a plurality of solid-state drives (SSDs). In an exemplary embodiment, the SSD ports 114 communicate with the backplane 104 through PCIe channels. Such SSD ports 114 may be non-volatile memory express (NVMe) ports, or the other similar ports. The motherboard 102 has a slot. Through the slot, the backplane 104 is connected to a central processing unit (CPU) 116 mounted on the motherboard 102. The CPU 116 has an SCI pin 117. The transmission line 110 for transferring the SCI alert signal specifically connects the backplane controller 112 to the SCI pin 117 of the CPU 116. In an exemplary embodiment, the SCI pin 117 of the CPU 116 is a pin conventionally used as an interrupt pin for detecting an opening or closing action of the cover of a notebook computer, but is not limited thereto.

The SSD hot-swapping at any of the SSD ports 114 can be presented to the backplane controller 112 through a corresponding presence signal 118 and, accordingly, the backplane controller 112 generates an SCI alert signal to be transferred to the SCI pin 117 of the CPU 116 through the transmission line 110. In response to the SCI alert signal received by the SCI pin 117, the CPU 116 starts a program to handle the hot-swapping event.

In an exemplary embodiment, as an SSD is connected to an SSD port (114), the corresponding presence signal 118 changes from high level to low level. On the contrary, as an SSD is removed from an SSD port (114), the corresponding presence signal 118 changes from low level to high level. Once the presence signal 118 changes, the backplane controller 112 alerts an SCI alert signal and transmit it to the SCI pin 117 of the CPU 116 via the transmission line 110 to notify the CPU 116. Under such an architecture, any hot-swapping event at the SSD ports 114 will cause the backplane controller 112 to alert an SCI alert signal and notify the CPU 116 through the transmission line 110, and the CPU 116 is triggered to call a program to handle the hot-swapping event.

In an exemplary embodiment, the backplane controller 112 may be implemented by a complex programming logic device (CPLD). In addition to what is shown in the figure, the backplane 104 may also include: an SSD status light (not shown in FIG. 1); and a bus port for connecting to the motherboard 102 (which may be connected to any PCIe bus that supports the PCIe 8GT rate, such as a SLIMLINE, etc.). The backplane 104 is not limited to supporting four SSDs as shown in the figure, but can also support other numbers of SSDs. For example, it can also support 8, 12 SSDs, etc. In addition, the interface model described in this paper is just an example to help understanding the disclosure, and can be replaced by the other types of interface.

In an exemplary embodiment, the SCI alert signal (110) provides an alert status to present a hot swapping event occurred at one of the SSD ports 114 on the backplane 104. The CPU 116 responds to the alert status of the SCI alert signal (110) and calls an SCI handler to handle the hot swapping event.

In an exemplary embodiment, in response to the alert status of the SCI alert signal 110, the CPU 116 running the operating system (OS) calls the SCI handler defined in the basic input and output system (BIOS) code based on an advanced configuration and power interface (ACPI) protocol, to determine where the hot-swapping event has occurred, and to identify whether the hot-swapping event is a hot plugging-in event or a hot plugging-out event.

In an exemplary embodiment, the SCI handler returns the notification to the operating system (OS) based on the ACPI protocol and, accordingly, the operating system (OS) performs device removal or a device registration for the SSD port where the hot-swapping event has occurred. In this manner, the server system 100 is not crashed by the hot-swapping event and can operate normally.

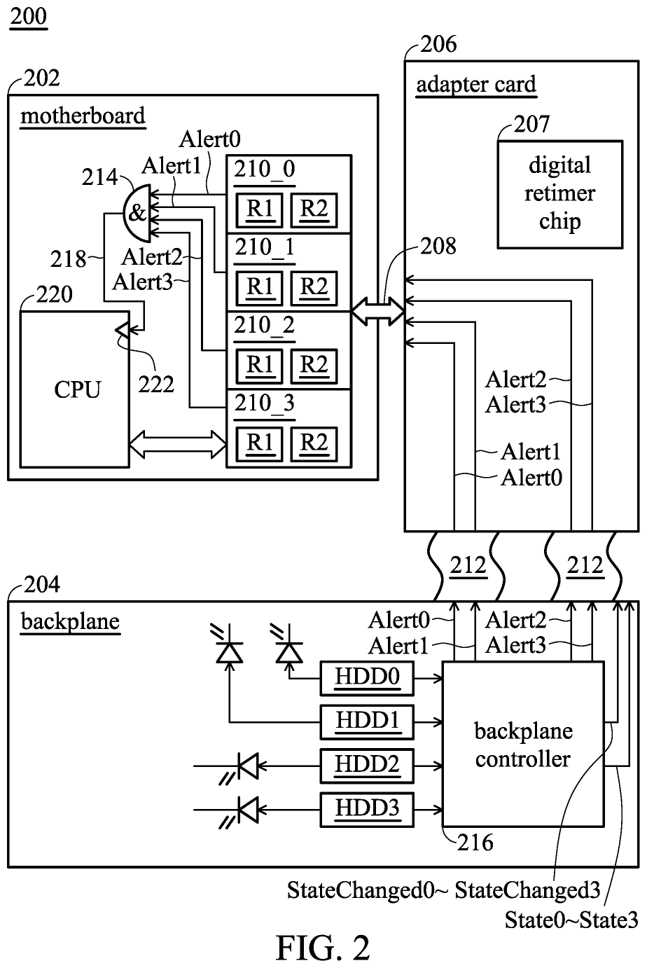

FIG. 2 illustrates a server system 200 in accordance with another exemplary embodiment of the disclosure. In addition to a motherboard 202 and a backplane 204, the server system 200 further has an adapter card 206. In an exemplary embodiment, the adapter card 206 is a PCIe adapter card. The illustrated backplane 204 not only provides SSD ports HDD0˜HDD3 for pluggable SSDs, but also provides indicator lights (LEDs) to display the status of the connected SSDs. The adapter card 206 may be equipped with a digital retimer chip 207 to ensure the quality of PCIe high-speed signals. The motherboard 202 and the adapter card 206 are connected through an adapter bus 208 that supports the PCIe protocol. In an exemplary embodiment, the adapter bus 208 is for a standard PCIe ×16 connector and may be configured to support four (×4) PCIe root ports (abbreviated as RP). The four root ports are respectively numbered 210_0˜210_3. The adapter card 206 and the backplane 204 may be connected through any bus 212 that supports the PCIe protocol (such as a Slimline).

Different from FIG. 1 in which the backplane controller 112 integrates the presence signals 118 of all SSD ports 114 to generate one single SCI alert signal (transferred through a simple transmission line 110), there is an AND gate 214 on the motherboard 202 of FIG. 2. The AND gate 214 generates the SCI alert signal on the motherboard 202. Specifically, the backplane controller 216 acts in response to any hot-swapping event at the SSD ports HDD0˜HDD3, to alert the corresponding interrupt alert signal (the corresponding one of Alert0˜Alert3, each 1 bit wide), connection status change signal (the corresponding one of StateChanged0˜StateChanged3), and connection status signal (the corresponding one of State0˜State3). These signals are transferred to the corresponding root port (the corresponding one of 210_0˜210_3) on the motherboard 202. The interrupt alert signals Alert0˜Alert3 are delivered to the logic AND gate 214 to generate the SCI alert signal 218 to be transferred to the SCI pin 222 of the CPU 220 on the motherboard 202. As shown in the figure, the different root ports 210_0˜210_3 on the motherboard 202 correspond to the different SSD ports HDD0˜HDD3 on the backplane 204. The root port 210_0 corresponds to the SSD port HDD0 and can receive the interrupt alert signal Alert0, the connection status change signal StateChanged0, and the connection status signal State0 generated for the SSD port HDD0. The root port 210_1 corresponds to the SSD port HDD1 and can receive the interrupt alert signal Alert1, the connection status change signal StateChanged1, and the connection status signal State1 generated for the SSD port HDD1. The root port 210_2 corresponds to the SSD port HDD2 and can receive the interrupt alert signal Alert2, the connection status change signal StateChanged2, and the connection status signal State2 generated for the SSD port HDD2. The root port 210_3 corresponds to the SSD port HDD3 and can receive the interrupt alert signal Alert3, the connection status change signal StateChanged3, and the connection status signal State3 generated for the SSD port HDD3. According to the connection status change signal StateChanged # and the connection status signal State #received by each root port 210_#(# is a number), each root port 210_#programs its registers R1 and R2 (detailed below) to show the status of the corresponding SSD port HDD #.

The interrupt alert signals Alert0˜Alert3, the connection status change signals StateChanged0˜StateChanged3, and the connection status signals State0˜State3 issued by the backplane controller 216 are transferred to the root ports 210_0˜210_3 through the adapter card 206 and, accordingly, the corresponding root port 210_#sets its registers. Each root port 210_#includes at least two registers: a register R1, indicating whether a hot-swapping event has occurred at the corresponding SSD port; and, a register R2, indicating whether the corresponding SSD port is in use (active). Later, based on registers R1 and R2 of each root port 210_#, the SCI handler determines whether a hot-swapping event has occurred at any SSD ports, and determines whether the detected hot-swapping event is a hot plugging-in event or a hot plugging-out event. For example, when an SSD is removed from the SSD port HDD0, the backplane controller 216 changes the connection status change signal StateChanged0 and the connection status signal State0. Through the adapter card 206, the connection state change signal StateChanged0 and the connection state signal State0 are sent to the root port 210_0. In response to the connection status change signal StateChanged0, in the root port 210_0, a value “1” is stored into the register R1 to indicate that a hot-swapping event has occurred at the SSD port HDD0. In response to the connection status signal State0, in the root port 210_0, a value is programmed into the register R2. In an exemplary embodiment, when the connection status signal State0 shows DL_Active (indicating that the link is normally available), in the root port 210_0, the register R2 is set to 1, indicating that the SSD port HDD0 is in use. When the connection status signal State0 is DL_InActive (indicating that the link is invalid), in the root port 210_0, the register R2 is cleared to 0, indicating that the SSD port HDD0 is not in use. Thus, if the register R2 is “0”, it means that the SSD port HDD0 with the hot-swapping event is not in use, and the hot-swapping event is a hot plugging-out event. If the register R2 is “1”, it means that the SSD port HDD0 with the hot-swapping event is in use, and the hot-swapping event is a hot plugging-in event. For example, if the SCI handler scans that the values of register R1 and register R2 of the root port 210_0 are both “1”, it is confirmed that a hot plugging-in event has occurred at the SSD port HDD0.

FIG. 2 takes four SSD ports HDD0˜HDD3 as an example. The illustrated components may be expanded with the number of SSDs. Taking a server system with 12 SSD ports as an example, three adapter cards 206 are required, and the motherboard 202 provides 12 root ports.

Any hot-swapping event occurred at the SSD ports on the backplane should drive the SCI pin 222 of the CPU 220 to ensure that all hot plugging-in or hot plugging-out events are reported to the CPU 220 without being missed. No matter how many backplanes (204) are used in the system, they can all share the same SCI pin 222 to connect to the CPU 220. The circuit design will ensure that any SSD hot swapping event occurred on the backplanes can trigger the signal on the SCI pin 222 of the CPU 220 (making the SCI alert signal switch to an alert status).

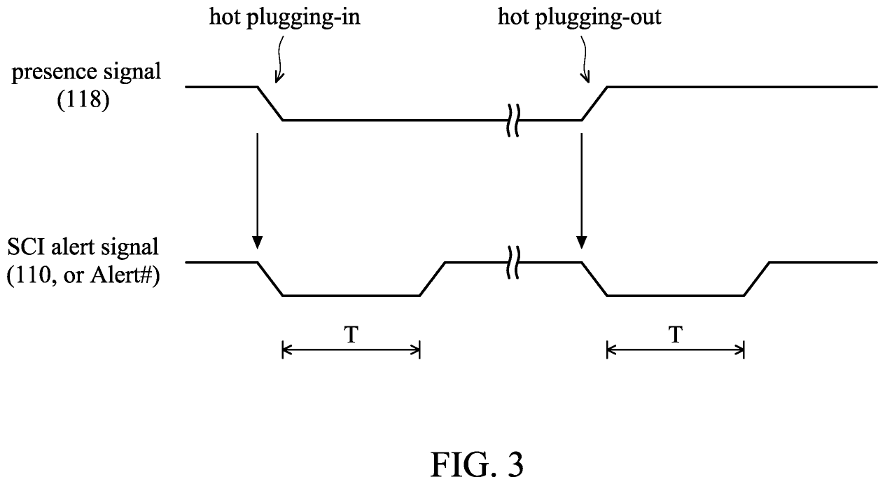

FIG. 3 shows a waveform diagram illustrating how the SCI alert signal (or the interrupt alert signals Alert #) changes with the hot swapping events. A presence signal of an SSD port (referring to 118 of FIG. 1) is pulled down with the hot plugging-in of an SSD, and is pulled up with the hot plugging-out of an SSD. In response to the change occurs on the presence signals, the SCI alert signal is pulled down for a fixed duration T (switched to an alert status). In this disclosure, the level restoration (pull-up) of the SCI alert signal is not triggered by the CPU or the motherboard. The SCI alert signal changes back to its default status after the fixed duration T (that is long enough for the CPU to correctly sample the change at the SCI pin). By such an automatic level restoration (pull-up) design for the SCI alert signal, consecutive hot-swapping events are correctly detected without being missed.

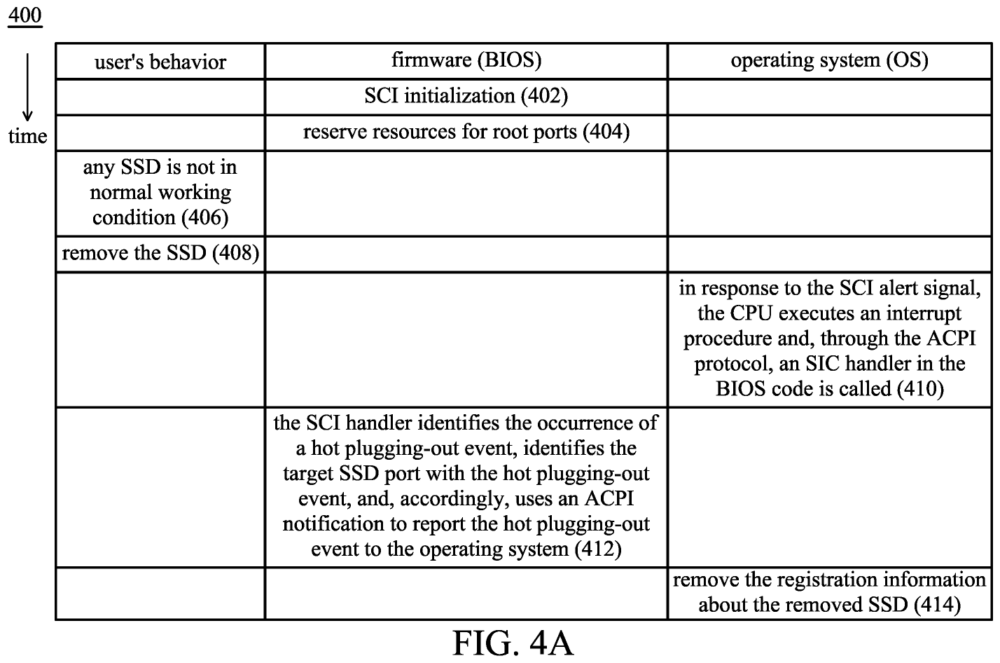

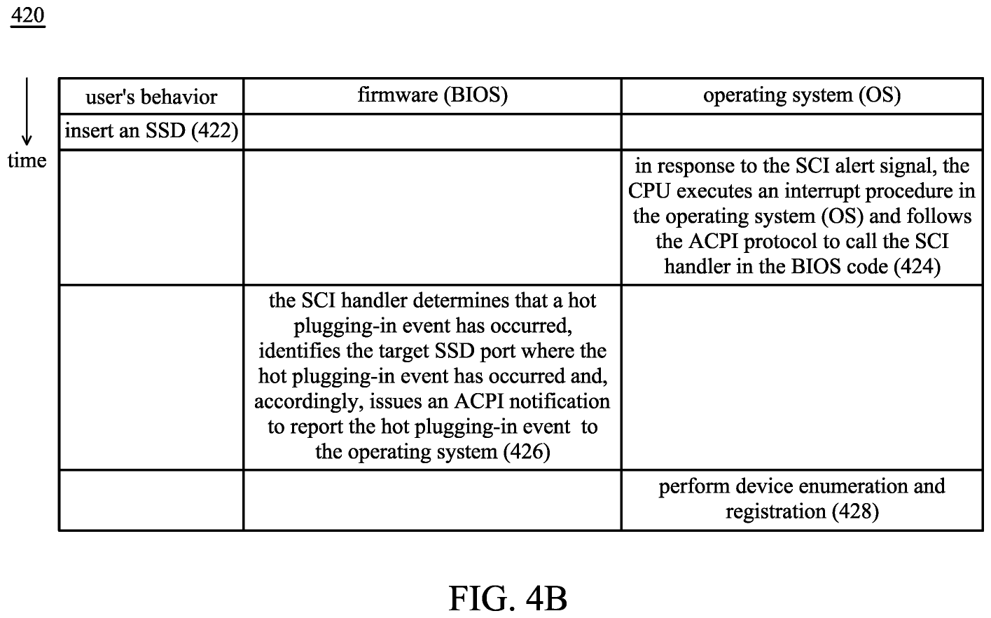

FIG. 4A shows a timing diagram 400 illustrating the interaction between the user, firmware (Basic Input Output System, abbreviated as BIOS), and operating system (OS) when a hot plugging-out event has occurred.

The firmware (BIOS) first performs SCI initialization (402), by which the SCI pin of the CPU is enabled, the trigger level of the SCI pin is determined, and the SCI handler is ready.

Next, the firmware (BIOS) reserves resources (404) for the root ports (regardless of whether the corresponding SSD port has been connected to an SSD or not). For example, the reserved resources may include planning of a memory-mapped I/O (MMIO), . . . , etc.

When determining that an SSD is not in normal working condition (406), the user can remove the SSD (408). In response to the hot plugging-out event, an SCI alert signal is alerted and transferred to the SCI pin to notify the CPU. In response to the SCI alert signal, the CPU executes an interrupt procedure and, through the ACPI protocol, an SIC handler in the BIOS code is called (410).

The SCI handler identifies the occurrence of a hot plugging-out event, and identifies the target SSD port with the hot plugging-out event (for example, by checking the registers R1 and R2 of each root port of FIG. 2). Accordingly, the SCI handler uses an ACPI notification to report (412) the hot plugging-out event to the operating system (OS). According to the report about the hot plugging-out event, the operating system (OS) removes the registration information about the removed SSD (414).

FIG. 4B shows a timing diagram 420 illustrating the interaction between the user, firmware (BIOS), and operating system (OS) when a hot plugging-in event has occurred. For simplification, the SCI initialization (402) and resource reservation (404) for the root ports illustrated in diagram 400 are not presented in the diagram 420.

After the user inserts the SSD (422), the backplane controller alerts and transfers the SCI alert signal to the SCI pin of the CPU. In response to the SCI alert signal, the CPU executes an interrupt procedure in the operating system (OS) and follows the ACPI protocol to call the SCI handler in the BIOS code (424).

The SCI handler in the firmware (BIOS) determines that a hot plugging-in event has occurred, and identifies the target SSD port where the hot plugging-in event has occurred (for example, by checking the registers R1 and R2 of each root port of FIG. 2). The SCI handler issues an ACPI notification to report the hot plugging-in event to the operating system (OS) (426). According to the report about the hot plugging-in event, the operating system (OS) performs device enumeration and registration (428).

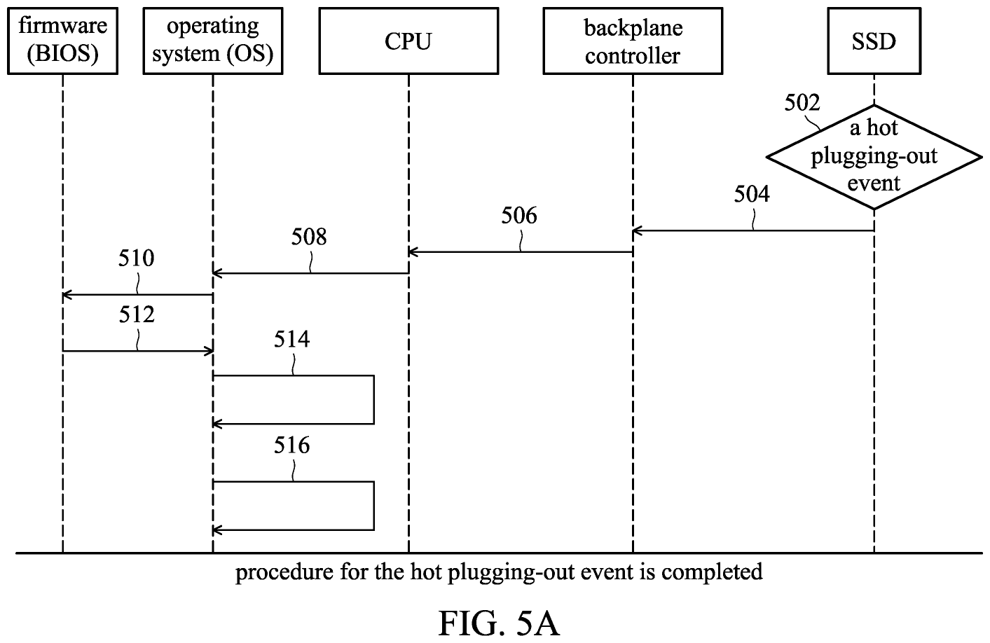

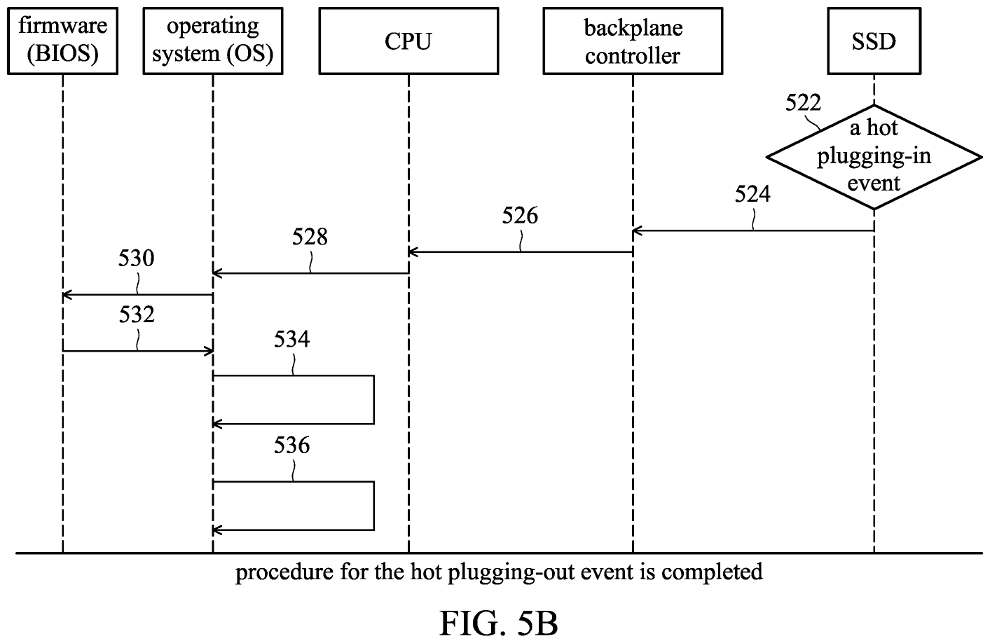

FIG. 5A illustrates the server's processing flow about a hot plugging-out event.

In response to a hot plugging-out event (502), a presence signal is pulled high level (referring to FIG. 3) to notify the backplane controller (504). The backplane controller changes an SCI alert signal (506) to an alert status (for example, changing to low level). In response to the alert status of the SCI alert signal detected at the SCI pin of the CPU, the operating system (OS) executes an interrupt procedure (508) to call an SCI handler (510) registered in the BIOS to determine the occurrence of the hot plugging-out event, and identify the target SSD port where the hot plugging-out event has occurred. The firmware (BIOS) notifies the operating system (OS) to perform device removal (512). The operating system (OS) operates an SSD driver (for example, an NVMe driver) to stop operating the removed SSD (514), and operates a bus driver (for example, a PCIe bus driver) to perform device enumeration (516) and update the registration for the removed SSD.

FIG. 5B illustrates the server's processing flow about a hot plugging-in event. In response to a hot plugging-in event (522), a presence signal is pulled low level (referring to FIG. 3) to notify the backplane controller (554). The backplane controller changes the SCI alert signal (526) to an alert status (for example, changing to low level). In response to the alert status of the SCI alert signal detected at the SCI pin of the CPU, the operating system (OS) executes an interrupt procedure (528) to call the SCI handler (530) registered in the BIOS to determine the occurrence of the hot plugging-in event, and identify the target SSD port where the hot plugging-in event has occurred. The firmware (BIOS) notifies the operating system (OS) to perform device registration (532). The operating system (OS) operates the bus driver (for example, a PCIe bus driver) to perform device enumeration (534), and operates the SSD driver (for example, an NVMe driver) to normally operate the connected SSD (536).

According to the design of this disclosure, in the booting procedure, the firmware (BIOS) operated in FIGS. 5A and 5B may reserve resources for the root ports which support hot swapping. Moreover, the firmware (BIOS) configures the root ports that support hot swapping to prevent them from entering a power-saving mode. Conventionally, a root port that does not support hot swapping is switched to a power-saving mode if the SSD port corresponding to the root port is not in use. In the booting procedure, the firmware (BIOS) of the disclosure further initializes the various registers (such as the aforementioned registers R1 and R2) required in the execution of the SCI handler.

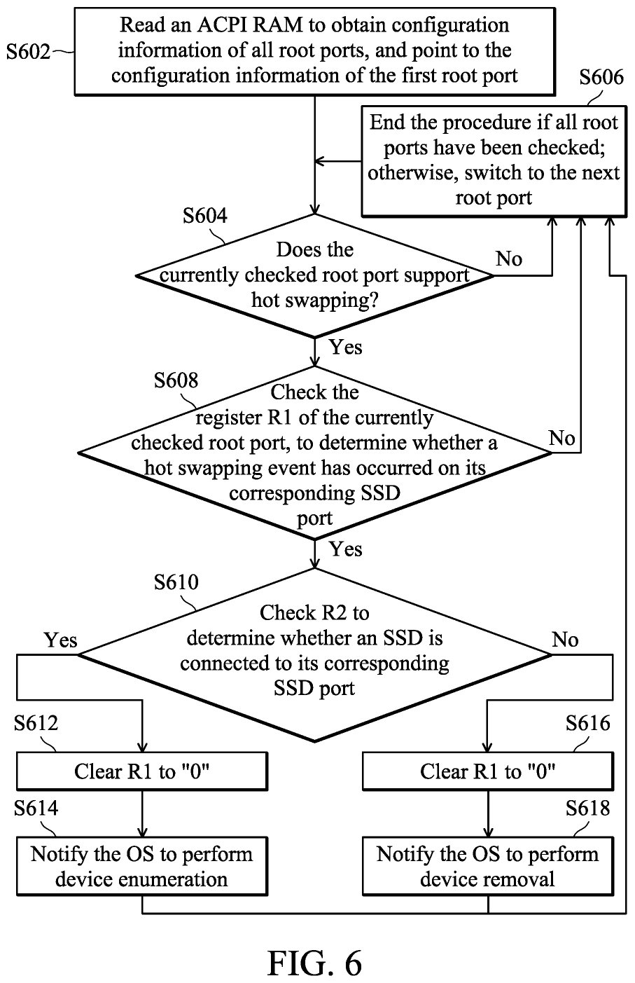

FIG. 6 is a flow chart illustrating the actions of the SCI handler executed by the firmware (BIOS). In the execution of the SCI handler, each root port is inspected to determine whether a hot-swapping event has occurred, and handles it properly. The processing flow of the SCI handler is described in detail below.

The configuration information of all root ports may be stored in an ACPI random access memory (ACPI RAM), and which root ports support hot swapping may be record in the configuration information. In an exemplary embodiment, the configuration information of each root port includes a hotplug field or bit. If the hotplug field or the bit value is 1, it means that the corresponding root port supports hot swapping. If the hotplug field or bit value is 0, it means that the corresponding root port does not support hot swapping. The triggered SCI handler first performs step S602 to read the ACPI RAM, to obtain all configuration information from the first root port to the final root port. Specifically, in step S602, the configuration information of all root ports read from the ACPI RAM is programed as a configuration table. Then, the SCI handler points to (or selects) the first entry of the configuration table, and the root port corresponding to the configuration information stored in the first entry of the configuration table is checked first. In an exemplary embodiment, the structure of the configuration table is as shown in Table 1 below: entry 1 stores the configuration information of the root port 210_0, entry 2 stores the configuration information of the root port 210_1, and so on.

TABLE 1
configuration information of root port 210_0
configuration information of root port 210_1
. . .

Next, step S604 is performed to determine whether the currently checked root port supports hot swapping. Specifically, the SCI handler reads the configuration information of the currently checked root port from the configuration table and determines whether its hotplug field or bit value is 1 or 0. If its hotplug field or bit value is 0, it means that the currently checked root port does not support hot swapping, and then step S606 is performed to switch to the next root port to check whether the next root port supports hot swapping. If the obtained hotplug field or bit value is 1, it means that the currently checked root port supports hot swapping. Then, step S608 is executed to check the register R1 of the currently checked root port, to determine whether a hot swapping event has occurred on its corresponding SSD port. If the register R1 of the currently checked root port is not set to “1”, it means that a hot-swapping event has not occurred at its corresponding SSD port.

If step S608 determines that the register R1 of the currently checked root port is “1” (that is, a hot swapping event has occurred on its corresponding SSD port), step S610 is then performed to check the register R2 of the currently checked root port and determine whether an SSD is connected to its corresponding SSD port (whether R2 is in the Active state). If there is a connected SSD, step S612 is performed to clear the register R1 to “0” (by which a port connection change register of the currently checked root port is cleared), and step S614 is performed to notify the operating system (OS) to perform device enumeration on the root port to register this newly connected SSD.

If step S610 determines, based on the register R2, that the SSD port corresponding to the currently checked root port is not connected to any device, the procedure proceeds to step S616 to clear the register R1 to “0” (by which the port connection change register of the currently checked root port is cleared). Then, in step S618, the operating system (OS) is triggered to perform device removal on the currently checked root port.

After step S614/S618, step S606 is performed. If all root ports have been checked, the procedure ends. Otherwise, the next root port is checked. Specifically, in step S606, it is determined whether all root ports have been checked. In an exemplary embodiment, the SCI handler may determine whether all root ports have been checked by determining whether all entries in the configuration table have been checked. If not all root ports have been checked, it is switched to the next root port (that is, switch to the next entry in the configuration table) to perform steps S604 to S618 for hot-swapping checking of the next root port. If all root ports have been checked, the SCI handler ends its execution.

Through the proposed server system and proposed method for implementing SSD hot-swapping on a server, the CPU of a server is notified of an SSD hot-swapping event through an SCI pin of the CPU. Using this design, any CPU used in server applications, or any server system including a motherboard and a backplane, falls within the scope of this disclosure.

In an exemplary embodiment, a method for implementing SSD hot-swapping on a server based on the above concept is shown. The method receives an SCI alert signal via an SCI pin of a CPU, wherein the alert status of the SCI alert signal reflects the occurrence of a hot-swapping event at any SSD port on a backplane. In response to the alert status of the SCI alert signal, an SCI handler is called to handle the hot-swapping event.

In response to the alert status of the SCI alert signal, according to the method, the CPU running the operating system (OS) calls the SCI handler based on the ACPI protocol. According to the execution of the SCI handler, the target SSD port where the hot-swapping event has occurred is identified, and it is determined whether hot-swapping event is a hot plugging-in event or a hot plugging-out event.

According to the method, the SCI handler also returns the notification to the operating system (OS) according to the ACPI protocol, and the operating system (OS) performs device removal or device registration for the SSD port where the hot-swapping event has occurred.

According to the method, when the server runs BIOS after power-on or reset, computing resources are reserved for the SSD ports to support hot-swappable SSDs.

According to the method, a PCIe bus is connected between a motherboard carrying a CPU and a backplane. The motherboard includes a plurality of root ports corresponding to the SSD ports on the backplane, and each root port (RP) has a first register and a second register. The first register indicates whether a hot-swapping event has occurred at the corresponding SSD port. The second register indicates whether the corresponding SSD port is in use. Based on each pair of registers R1 and R2 of the different root ports, the SCI handler identifies the target SSD port where the hot-swapping event has occurred, and identifies whether it is a hot plugging-in event or a hot plugging-out event.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A server system, comprising:
a central processing unit, having a system-control-interrupt pin operative to receive a system-control-interrupt alert signal,
wherein an alert status of the system-control-interrupt alert signal reflects a hot-swapping event occurred at any of a plurality of solid-state drive ports on a backplane, and the central processing unit calls a system-control-interrupt handler to handle the hot-swapping event in response to the alert status of the system-control-interrupt alert signal.

2. The server system as claimed in claim 1, wherein:
in response to the alert status of the system-control-interrupt alert signal, the central processing unit running an operating system calls the system-control-interrupt handler according to an advanced configuration and power interface protocol, to identify a target solid-state drive port where the hot-swapping event has occurred, and to determine whether the hot-swapping event is a hot plugging-in event or a hot plugging-out event.

3. The server system as claimed in claim 2, wherein:
the system-control-interrupt handler returns a notification to the operating system according to the advanced configuration and power interface protocol; and
in response to the notification, the operating system performs device removal or device registration on the target solid-state drive port.

4. The server system as claimed in claim 1, running a basic input and output system to reserve resources for the solid-state drive interface ports to support hot swapping of solid-state drives.

5. The server system as claimed in claim 1, wherein:
the alert status is at a low level for a fixed duration; and
the fixed duration depends on a sampling rate at which the central processing unit samples the system-control-interrupt alert signal received by the system-control-interrupt pin.

6. The server system as claimed in claim 1, further comprising:
a motherboard, having the central processing unit mounted thereon; and
the backplane, comprising a backplane controller as well as providing the solid-state drive ports, wherein, in response to the hot-swapping event, the backplane controller changes the system-control-interrupt alert signal to the alert status.

7. The server system as claimed in claim 6, wherein:
on the backplane, there are lines between the solid-state drive ports and the backplane controller, configured to transmit presence signals from their corresponding solid-state drive ports to the backplane controller;
each presence signal changes its level in response to a hot-swapping event occurred at its corresponding solid-state drive port; and
the system-control-interrupt alert signal is switched to the alert status in response to a level change at any of the presence signals.

8. The server system as claimed in claim 6, further comprising:
a bus, coupled between the motherboard and the backplane,
wherein the bus works based on a peripheral component interconnect express protocol.

9. The server system as claimed in claim 8, further comprising:
a transmission line, coupled between the motherboard and the backplane; and
wherein the system-control-interrupt alert signal is generated by the backplane controller, transmitted from the backplane to the motherboard via the transmission line, and received by the system-control-interrupt pin of the central processing unit.

10. The server system as claimed in claim 8, wherein:
in response to hot-swapping events occurred at different solid-state drive ports, different interrupt alert signals are changed to alert status by the backplane controller; and
the motherboard has a logic AND gate that receives the interrupt alert signals to generate the system-control-interrupt alert signal to be received by the system-control-interrupt pin of the central processing unit.

11. The server system as claimed in claim 10, wherein:
the motherboard further provides a plurality of root ports, corresponding to the solid-state drive ports on the backplane, and each has a first register and a second register, wherein the first register indicates whether a hot-swapping event has occurred on the corresponding solid-state drive port, and the second register indicates whether the corresponding solid-state port is in use; and
each root port programs its corresponding first register in response to a connection status change signal of its corresponding solid-state drive port, and programs its corresponding second register in response to a connection status signal of its corresponding solid-state drive port; and
based on the first register and the second register of each root port, the system-control-interrupt handler identifies a target solid-state drive port where the hot-swapping event has occurred, and determines whether the hot-swapping event is a hot plugging-in event or a hot plugging-out event.

12. The server system as claimed in claim 11, wherein:
after identifying the target solid-state drive port and determining whether the hot-swapping event is a hot plugging-in event or a hot plugging-out event, the system-control-interrupt handler clears the first register.

13. The server system as claimed in claim 3, wherein:
in response to the notification about the hot plugging-out event that the system-control-interrupt handler returns to the operating system through the advanced configuration and power interface protocol, the operating system operates a solid-state drive driver to stop operating the target solid-state drive port, and operates a peripheral-component interconnect-express driver to perform device enumeration on the target solid-state drive port to implement the device removal.

14. The server system as claimed in claim 3, wherein:
in response to the notification about the hot plugging-in event that the system-control-interrupt handler returns to the operating system through the advanced configuration and power interface protocol, the operating system operates a peripheral-component interconnect-express driver to perform device enumeration on the target solid-state drive port to implement the device registration, and operates a solid-state drive driver to operate a solid-state drive connected to the target solid-state drive port by the hot-swapping event.

15. The server system as claimed in claim 11, further comprising:
an adapter card, connected to the backplane via a connecting cable, and configured to receive the interrupt alert signals generated by the backplane controller,
wherein the adapter card is further connected to the motherboard via an adapter bus to supply the interrupt alert signals to the root ports, where the adapter bus supports the advanced configuration and power interface protocol.

16. A method for implementing hot-swapping on a server, comprising:
receiving a system-control-interrupt alert signal at a system-control-interrupt pin of a central processing unit of a server, wherein an alert status of the system-control-interrupt alert signal reflects a hot-swapping event occurred at one of a plurality of solid-state drive ports on a backplane of the server; and
operating a system-control-interrupt handler to handle the hot-swapping event in response to the alert status of the system-control-interrupt alert signal.

17. The method as claimed in claim 16, wherein:
in response to the alert status of the system-control-interrupt alert signal, the central processing unit running an operating system calls the system-control-interrupt handler according to an advanced configuration and power interface protocol, to identify a target solid-state drive port where the hot-swapping event has occurred, and to determine whether the hot-swapping event is a hot plugging-in event or a hot plugging-out event.

18. The method as claimed in claim 17, wherein:
the system-control-interrupt handler returns a notification to the operating system according to the advanced configuration and power interface protocol; and
in response to the notification, the operating system performs device removal or device registration on the target solid-state drive port.

19. The method as claimed in claim 16, further comprising:
running a basic input and output system in a power-on procedure of the server to reserve resources for the solid-state drive interface ports to support hot swapping of solid-state drives.

20. The method as claimed in claim 16, further comprising:
providing a peripheral component interconnect express bus between a motherboard carrying the central processing unit and the backplane;
wherein:
the motherboard further provides a plurality of root ports, corresponding to the solid-state drive ports on the backplane, and each has a first register and a second register, wherein the first register indicates whether a hot-swapping event has occurred on the corresponding solid-state drive port, and the second register indicates whether the corresponding solid-state port is in use; and
based on the first register and the second register of each root port, the system-control-interrupt handler identifies a target solid-state drive port where the hot-swapping event has occurred, and determines whether the hot-swapping event is a hot plugging-in event or a hot plugging-out event.
